(19) United States
(12) Patent Application Publication
(10) Pub. No.: US 2005/0269508 A1
(43) Pub. Date: Dec. 8, 2005

(54) Apparatus and methods for detecting compounds using mass spectra

(76) Inventors: Timothy P. Lippa, Towson, MD (US); Bernard F. Collins, Silver Spring, MD (US)

Correspondence Address: Office of Patent Counsel;The Johns Hopkins University Applied Physics Lab., 11100 Johns Hopkins Road, MS 7-156, Laurel, MD, 20723-6099, US

(21) Appl. No.: 11/144,509

(22) Filed: Jun. 3, 2005

Related U.S. Application Data
(60) Provisional application No. 60/576,709, filed on Jun. 3, 2004.
(60) Provisional application No. 60/584,209, filed on Jun. 30, 2004.
(60) Provisional application No. 60/584,348, filed on Jun. 30, 2004.

(51) Int. Cl. B01D 59/44

(52) U.S. Cl. 250/292

(57) ABSTRACT

An apparatus and method for rapidly and reliably detecting compounds of interest using mass spectra. For the apparatus, an ion mobility spectrometer is connected to an electron ionization cell which, in turn, is connected to a time-of-flight mass spectrometer. For the method, mass spectra for a compound of interest are pre-selected and then averaged over a plurality of ion, mobility spectrometer scans to create a mass spectrum which is matched against the fingerprint of the compound of interest produced by fragmenting the ions in the electron ionization cell. Additionally, a feedback mechanism is disclosed for optimizing the maximum allowable extraction frequency in the mass spectrometer.

### CROSS-REFERENCE TO RELATED APPLICATIONS

This application claims the benefit of U.S. Provisional Applications 60/576,709, filed Jun. 3, 2004; 60/584,209, filed Jun. 30, 2004; and 60/584,348, filed Jun. 30, 2004, the entire contents of which are hereby incorporated by reference as if fully set forth herein, under 35 U.S.C. §119(e).

### BACKGROUND OF THE INVENTION

1. Field of the Invention

The present invention relates to ion mobility, mass spectrometry, mass spectrometers and apparatus and methods therefor.

2. Background

Mass spectrometers provide a fundamental tool of analytical and experimental chemistry and have proven useful and reliable in identification of chemical and biological samples. Electron ionization mass spectrometry is a very sensitive technique used to determine the masses of molecules and specific fragmentation products formed-following vaporization and ionization.

Detailed analysis of the mass distribution of the parent molecular ion and its fragments leads to chemical identification with a high degree of confidence. The combination of specific identification and extreme sensitivity makes mass spectrometry one of the most powerful analytical tools available.

Gas chromatography/mass spectrometry (GC/MS) is the “gold standard” chemical analysis technique, yielding very high confidence results based on highly specific mass spectral “fingerprints” of separated, pure compounds. These spectral fingerprints are typically produced via an electron ionization cell that can reliably produce ion fragmentation patterns in-specific repeatable ratios. However, GC/MS suffers-from slow detection times. Even with the most recent advances in fast chromatography, detection times are on the order of 1 to 15 minutes. A reliable apparatus that dramatically increases sample detection times is needed.

Detection sensitivity is mass dependent on instruments that currently incorporate orthogonal extraction/acceleration ion sources due to having a fixed frequency extraction duty cycle.

In the typical operation of an orthogonal acceleration mass spectrometer, ions enter the mass spectrometer source region orthogonal to the extraction field and, hence, the ion beam transport axis. Typically the ions enter the extraction region when it is field free. After the ions are allowed to fill the extraction region, voltages are applied to the extraction electrodes and the ions are accelerated along the flight axis and subsequently detected in time as a function of their mass.

The extraction region then is configured to do many extractions at a set frequency. The efficiency of ion extraction is given by the geometry of the source and the mass and energy of the ions being analyzed. It is currently understood that there is a maximum extraction frequency that can be set on the extraction electrodes on an orthogonal acceleration mass spectrometer due to mass limitations. The duty cycle for ions filling the extraction volume versus ions being extracted is typically on the order of 10%-30% depending on the factors above. As noted above, because current instruments set the extraction frequency constant, the instrument loses sensitivity due to the mass dependence of this extraction frequency.

### SUMMARY OF THE INVENTION

The invention solves the problems of the prior art by coupling an ion mobility spectrometer (IMS) to an electron ionization cell which, in turn, is coupled to an orthogonal acceleration TOF mass spectrometer.

The ion mobility spectrometers coupled to mass spectrometers that currently exist detect molecular parent ions. Incorporating the electron ionization cell between the two spectrometers will cause the parent ions to fragment which will produce a plurality of ions for each parent. In an analogous fashion to GC/MS, these detected fragments will then produce a spectral fingerprint that can be used to increase the instrument's sensitivity and selectivity, and will do so in a much more rapid fashion (seconds versus minutes).

Additionally, the invention as disclosed and claimed maximizes the mass spectrometer extraction duty cycle and, hence, ion detection efficiency by changing the extraction frequency in real time dependent upon the mass of the ions being analyzed.

### BRIEF DESCRIPTION OF THE DRAWINGS

Various embodiments are described below with reference to the drawings.

FIG. 1 illustrates the ion mobility spectrometer/electron ionization cell/time-of-flight mass spectrometer embodiment of the invention.

FIG. 2 illustrates the invention as shown in FIG. 1 with the addition of a thermal desorption cell coupled to the inlet of the ion mobility spectrometer.

FIG. 3 illustrates the inventive feedback mechanism that allows the mass spectrometer to respond in real time to maximize signal sensitivity dependent upon the mass of the species present during the analysis.

### DETAILED DESCRIPTION OF THE PREFERRED EMBODIMENT(S)

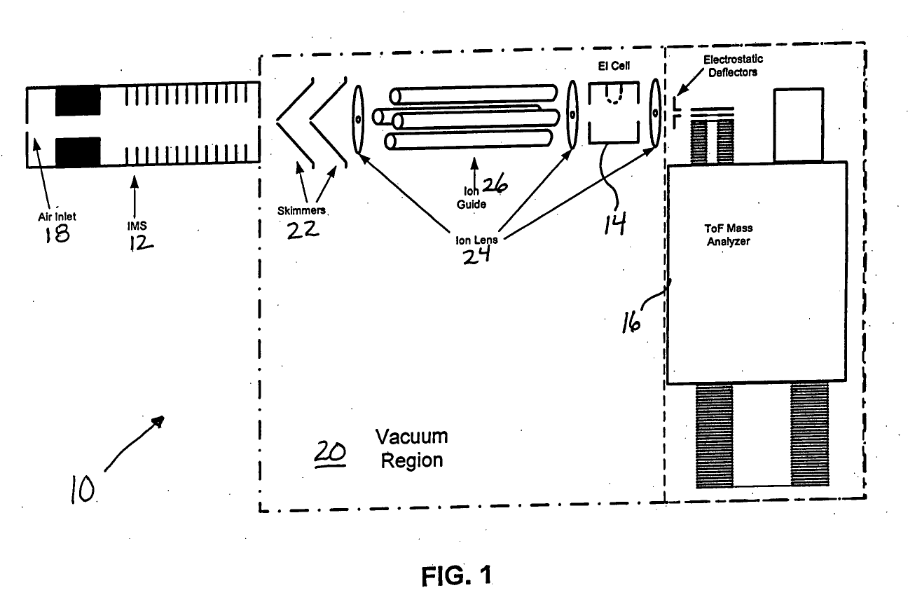

As shown in FIG. 1, an embodiment of the invention comprises an instrument 10 that combines an ion mobility spectrometer (IMS) 12 coupled to an electron ionization cell 14 which is, in turn, coupled to an orthogonal acceleration time-of-flight (TOF) mass spectrometer 16. Each of these three devices can be conventional as can be seen in U.S. Pat. No. 6,841,773, issued Jan. 11, 2005, U.S. Pat. No. 6,744,043, issued Jun. 1, 2004, and U.S. Pat. No. 6,559,441, issued May 6, 2003; and published U.S. patent application, pub. no. 2004/0245452, pub. date Dec. 9, 2004, all of which are hereby incorporated by reference herein in their entirety. Therefore, some details are not shown.

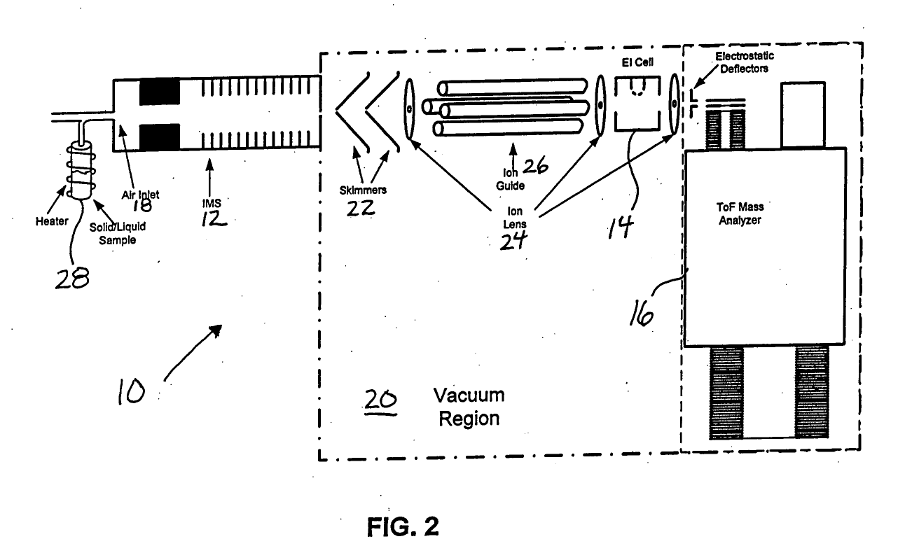

For example, in a known manner, the TOF mass spectrometer would include means for admitting ions, accelerating a selected group of ions into a drift tube with a detector at the end of the drift tube (linear but reflectron-type may also be used) for detecting the ions and measuring the time-of-flight. An orthogonal configuration is indicated in FIGS. 1 and 2.

In operation, atmospheric pressure gas enters the inlet 18 of the ion mobility spectrometer 12 source. The gas is ionized before being pulsed toward a detector. Analogous to most chromatographic separations, ions of differing collision cross section and geometry are separated in time as they move through the ion mobility cell.

Ions pass out of the ion mobility cell and into a vacuum chamber 20. Skimmers 22 and ion lenses 24 can be utilized to improve ion transport from atmospheric pressure to the pressures (10⁻⁵-10⁻⁷ torr) typically required for mass spectrometer operation. To further improve transport, the ions can be passed through an ion guide 26.

When the ions exit the ion guide they enter the electron ionization cell 14. Constant energy electrons fragment the ions producing a plurality of smaller ions for each parent ion. These fragmented ions then pass into an orthogonal extraction region of the time-of-flight mass spectrometer 16. The ions are pulse extracted at a constant voltage and, hence, can be detected in time as a function of their mass as described by

$$KE = \frac{1}{2} {mv}^{2} \qquad ( 1 )$$

where the Kinetic Energy (KE) is determined by the extraction potential, m is the ion mass and v is the ion's velocity. This gives arrival times t for a distance d proportional to the inverse of the square root of the mass

$$t = \sqrt{\frac{m}{2 * KE}} * d \qquad ( 2 )$$

The signal from the detector is measured by a time-to-digital converter (TDC) (not shown). The output of the TDC is averaged over 1 to 10 ms to enhance the signal-to-noise ratio (S/N) of the resulting mass spectra. The resulting data set is a single mass spectrum for each species eluted through the ion mobility cell. Each of these mass spectra will have a representative spectral fingerprint produced from the electron ionization source.

It is possible to reconstruct an ordinary IMS signal by integrating over each mass spectrum. It is more useful, however, to use the expected mobility of a compound of interest to pre-select only spectra measured during that compound's mobility “window.” By averaging pre-selected spectra over many IMS scans, it is possible to rapidly create a high S/N mass spectrum. Using a computer, the measured spectrum is compared to a library of spectral fingerprints, and, if the spectrum matches the compound of interest produced as a result of using the electron ionization source, very high confidence detection is possible, based on both the compound's characteristic mobility and its mass spectrum.

The invention is equally applicable for both negative and positive ions, as it is possible for the system to analyze both types of ions by simply reversing the polarities on the ion mobility spectrometer, transport optics, electron ionization cell and the time-of-flight mass spectrometer, Electron ionization cells have been shown to produce both cations and anions.

As shown in FIG. 2, in a refinement to the invention, a thermal desorption cell 28 is coupled to the inlet of the invention. This will allow for solid and liquid samples containing thermally labile compounds to be readily analyzed with the system. Samples are put into a heated cell and liberated vapors are mixed with ion mobility carrier gas or injected directly into the ion mobility ionization source.

As discussed above, the ions are chromatographically separated in the ion mobility spectrometer 12 and they pass out of the cell and into a vacuum chamber 20. The ions then pass through an ion guide 26 and then enter the electron ionization cell 14. Constant energy electrons fragment the ions producing several smaller ions for each parent ion. These fragmented ions then pass into an orthogonal extraction region of the time-of-flight mass spectrometer 16. The ions are pulse extracted at a constant voltage and hence can be detected in time as a function of their mass as is typical in time-of-flight mass spectrometry. This technique is applicable to both cation and anion analysis.

Combining thermal desorption capabilities with an ion mobility spectrometer/electron ionization cell/orthogonal acceleration time-of-flight mass spectrometer will provide a very sensitive and specific technique allowing solid and liquid samples to be analyzed for composition more rapidly than is currently possible with conventional analytical techniques.

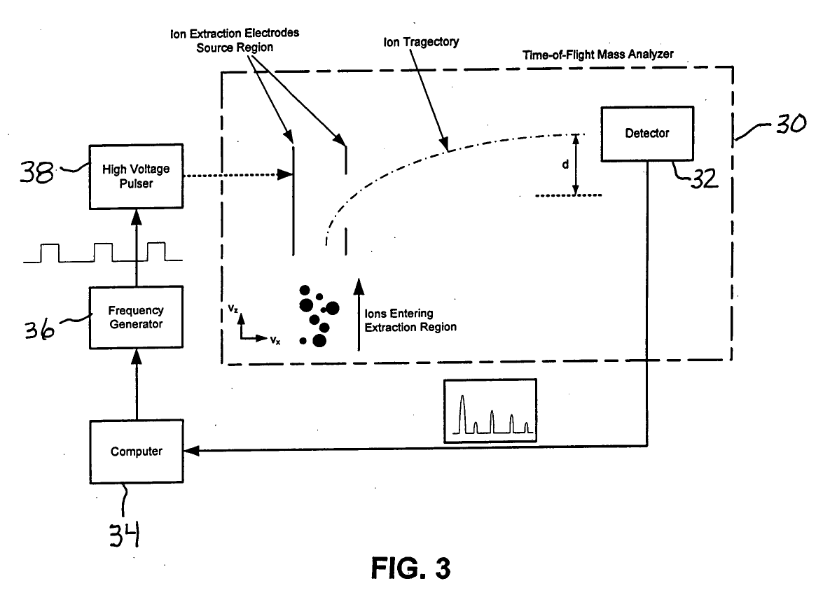

To properly analyze ions that use orthogonal extraction ion sources, it is necessary to allow all the ions from an extraction pulse to reach the detector before the subsequent pulse occurs. In a mass spectrometer, for example, a time-of-flight mass spectrometer 30 (see FIG. 3), when all of the ions are extracted at the same potential, the heaviest ion extracted will take the longest time to reach the detector 32. If a second extraction occurs before the heaviest ion from the previous extraction reaches the detector, the ion will appear as if it came from this second extraction and the recorded mass spectrum will be erroneous. Thus, the maximum extraction frequency that can be used without the possibility of having ions overlap from a previous extraction pulse is related to the time it takes for the heaviest ion to reach the detector on each extraction.

The time-of-flight calculation for the heaviest ion can be simplified by considering the ion's initial energies. When ions enter the extraction region their kinetic energy and, hence, their velocity are orthogonal to the electric field the ion experiences when it is extracted. Because the fields are orthogonal they can be decoupled and considered independently. The decoupling of the component velocities means that the time-of-flight for an extracted ion to reach the detector has to be equivalent to the time it would take the ion to reach the plane of the detector had the ion never been extracted.

Ions entering the extraction region have an initial kinetic energy (KE) given by

$$KE = \frac{1}{2} {mv ( z )}^{2} \qquad ( 3 )$$

where m is the ion mass and v(z) is the ion velocity orthogonal to the extraction direction (x). Both the kinetic energy and the mass are determined so the ion velocity can be calculated by rearranging equation (3) as follows:

$$v ( z ) = \sqrt{\frac{2 * KE}{m}} \qquad ( 4 )$$

and the time it takes for the ion to reach the detector center from the extraction region center is given simply by

$$t = \frac{d}{v ( z )} \qquad ( 5 )$$

where t is time, d is distance.

For a given set of masses the largest mass is chosen and the time (t) is calculated. The inverse of this time is the maximum allowable extraction frequency that can be used without contaminating subsequent spectra.

In light of the above, there are two possible methods to optimize the extraction frequency for the ions being analyzed. If there is prior knowledge of the ions being analyzed either empirically or experimentally (e.g., prior mass selection), then the extraction frequency can be changed dynamically to maximize ion extraction. Additionally, if the mass spectra of ions being analyzed is constant over some period of time, the information in these mass spectra can be sent to a computer 34 (FIG. 3) and used to feedback information related to the largest mass detected. The extraction frequency can be computed based on this as described above. A frequency generator 36 then sends the computed frequency to a pulser 38. Optimizing the extraction frequency in real-time, dependent on the species being analyzed, increases the detection capability of the instrument as more ions will reach the detector in the same scan time. It can also remove mass detection sensitivity biases, where at a set extraction frequency and given equal numbers of ions, more ions of a smaller mass will be extracted and reach the detector than compared to heavier ions.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

1. An apparatus for producing mass spectra comprising:
an ion mobility spectrometer (IMS) for ionizing a gas and separating the resulting parent ions in time;
an electron ionization cell connected to the ion mobility spectrometer for fragmenting the parent ions received from the IMS into a plurality of smaller ions for each parent ion; and
a mass spectrometer connected to the electron ionization cell for extracting the plurality of smaller ions and, thereafter, detecting the plurality of smaller ions in time as a function of their mass to produce a series of mass spectra.

2. The apparatus as recited in claim 1, wherein the mass spectrometer is a time-of-flight mass spectrometer.

3. The apparatus as recited in claim 1, further comprising a thermal desorption cell connected to an inlet to the ion mobility spectrometer for vaporizing solid and liquid samples.

4. A method for producing mass spectra comprising the steps of:
ionizing a gas using an ion mobility spectrometer thereby producing parent ions of different collision cross section and geometry and separating them in time;
fragmenting the parent ions using an electron ionization cell thereby producing a plurality of smaller ions for each parent ion;
detecting the plurality of smaller ions using a mass spectrometer; and
using a signal produced by the detected ions to produce the mass spectra.

5. The method as recited in claim 4 further comprising the steps of:
pre-selecting mass spectra measured during a window of expected mobility of a compound of interest;
averaging the pre-selected mass spectra over a plurality of scans of the ion mobility spectrometer;
creating a mass spectrum using the averaged pre-selected mass spectra; and
determining whether the mass spectrum matches a fingerprint of the compound of interest produced as a result of using the electron ionization cell.

6. The method as recited in claim 4, further comprising the steps of:
heating a sample to liberate vapors therefrom; and
mixing the liberated vapors from the sample with a carrier gas before the vapor-gas mixture enters the ion mobility spectrometer.

7. The method as recited in claim 4, further comprising the steps of:
calculating the maximum allowable extraction frequency that can be used in the mass spectrometer without contaminating subsequent spectra comprising the steps of:
selecting the largest mass for a given set of masses;
calculating the time that an ion with the largest mass will take to travel from the extraction region center to the detector center; and
obtaining the inverse of the calculated time to produce the maximum allowable extraction frequency; and
optimizing the maximum allowable extraction frequency comprising the step of dynamically changing the extraction frequency to maximize ion extraction based on the mass ions being analyzed.
